(19) United States
(12) Patent Application Publication
(10) Pub. No.: US 2005/0069470 A1
(43) Pub. Date: Mar. 31, 2005

(54) IRRADIATED FLUID BED REACTOR

(76) Inventors: David S Bettinger, Grosse Ile, MI (US); Christopher Paul, Albuquerque, NM (US)

Correspondence Address: DAVID S. BETTINGER, 8030 COVENTRY, GROSSE ILE, MI, 48138, US

(21) Appl. No.: 10/605,374

(22) Filed: Sep. 25, 2003

(51) Int. Cl. B01J 19/08

(52) U.S. Cl. 422/186

(57) ABSTRACT

A fluid bed reactor uses energy sources to excite and energize atomic components so as to effect and increase orbital energy. In a preferred embodiment light irradiates agitated particulate in a photolysis reaction to generate singlet oxygen in the gas phase. In a second embodiment microwave radiation stimulates a particulate linked endoperoxide to release singlet oxygen.

### FEDERAL RESEARCH STATEMENT

Not Applicable

### BACKGROUND OF INVENTION

In a typical fluid bed reactor, a distributed gas flow under pressure enters at the bottom or bed of the reactor, agitates the powder or particulate. This agitation allows gas to be exposed to generally all surfaces equally. The elevation of the solid particulate above the bed causes the particulate flow and hence the term fluid or fluidized-bed. For the purposes of this invention a fluidized bed has a generally circulating particulate flow pattern within the reactor. Fluid bed reactors may have a continuous exhaust of a portion of the treated charge. This loss is made up by a continuous supply of new untreated particulate. This supply may be required by the process as the particulate is combusted, consumed, or worn down. Fluid bed reactors are characterized by even exposure of the charge to a reactant such as heat over time. They are also characterized by easy operating control by variation of the gas flow.

In the prior art of fluid beds, more than 350 fluid bed reactors are in use worldwide for the manufacture of fuels, chemical intermediates, and plastics. The commercial synthesis of acrylonitrile, phthalic anhydride, aniline, maleic anhydride, and a portion of the polymerization of ethylene (to polyethylene) and propylene (to polypropylene) are all done in fluid bed reactors. There are noncatalytic processes, such as ore roasting, coking, combustion of coal and other solid fuels, as well as purely physical processes such as drying and conveying of fine particle products like flour, rice, and cement, which use the principles developed for the fine-particle fluidized bed.

The preferred embodiment of the invention is for the generation of singlet oxygen. Singlet oxygen has potential use in the chemical oxygen iodine laser (COIL). A current planned Department of Defense use of the COIL is in the Airborne Laser as a counter to ballistic missiles. Singlet oxygen also has potential in various metal processing plants and sanitation operations.

In the prior art, fluidized bed reactors are well described in US Patent Class 432/139. In the prior art, U.S. Pat. No. 4,476,098, Nakamori et al. discloses a “Microwave heated fluidized bed reactor having stages”. Nakamori uses heat in an aqueous reaction. Further, fluidized beds are being used currently by Vulcan Chemicals for the production of potassium carbonate as shown on their technical data sheet #TDS270-102.

In the prior art with regard to reactors for the chemical oxygen iodine laser, U.S. Pat. No. 6,072,820 disclosed by Dickenson, describes a reactor for SOG. Dickenson makes no provision for recirculating of unreacted material.

In regard to the use of polymer beads in a SOG reaction, U.S. Pat. Nos. 5,766,317 and 5,910,238 disclose “Microspheres for combined oxygen separation, storage, and delivery.” Neither relate to the use of a recirculating reactor. Related to the use of polymer beads, Mitchell et. al. discloses in U.S. Pat. No. 6,534,554 B1 a “Multicomponent for ion exchange resins”. Mitchell agglomerates reaction media particles without chemically binding.

In U.S. Pat. No. 5,439,652 Sczechowski, et al, uses controlled periodic illumination for an improved method of photocatalysis and an improved reactor design. Illumination is used although not strictly a fluidized bed because no material is recirculated and the illumination is periodic and not continuious.

In the prior art of using organic material as a transfer media for SOG, a paper by Thomas and Greer, printed in The Journal of Organic Chemistry, 2003, v. 68, p. 1886-1891, is relevant for the scope of the discussion. It deals specifically with atomic oxygen in the ground state, which is a triplet. However, it has several references to singlet atomic oxygen which provide excellent background.

In regard to the prior art of selecting a laser source compatible with a particular dye, Brasseur in Optic Letters, vol. 27, #11, Jun. 1, 2002, describes the selection of a light source emitting resonant Raman laser in an article titled “Highly efficient, resonant, Raman, molecular iodine laser.” Raman radiation by definition is energetic at the orbital level but is not specifically compatible with the material being lased. Also, relevant to the use of lasers to create reactions due to their energetic effect upon molecular structures, there exists the article by Arnold and Scaiano, and Bucher titled “Laser flash photolysis studies on 4-soxocyclohexa-2,5-dienylidenes” in The Journal of Organic Chemistry, Nov. 20, 1992, v. 57, p. 6469-74. Thus it is well known that lasers can be used for photolysis but there is no provision for compatible selection or emission within a circulating media.

In regard to the production of singlet oxygen from oxygen, the article by Scott, Fairley, and Milligan in The Journal of Physical Chemistry A, Sept. 16, 1999, v. 103, no. 37, p. 7470-3 titled “Gas phase reactions of some positive ions with atomic and molecular oxygen and nitric oxide at 300K” is relevant. In regard to SOG processes from ozone rather than oxygen, the following references apply: U.S. patent application No. 20030029734, “Integrated ozone generator system”, Andrews et al., Corey, Mehrotra, and Khan, “Generation of 1Dg O2 from triethylsilane and ozone”, Journal of the American Chemical Society, Apr. 30, 1986, v. 108, p. 2472-3, Wasserman, Yoo, and DeSimone, “Singlet oxygen reactions from the adducts of ozone with heterocyclic substrates”, Journal of the American Chemical Society, Sept. 27, 1995, v. 117, p. 9772-3, and Eisenberg, Taylor, and Murray, “Gas-phase generation of singlet oxygen by reaction of ozone with organic substances”, Journal of the American Chemical Society, Dec. 25, 1985, v. 107, p. 8299-300.

In regard to using oxygen as a transfer media in a continuous reactor, the following US patents are relevant: U.S. Pat. No. 4,563,413 “Photopolymer process and composition employing a photooxidizable component capable of forming endoperoxides” U.S. Pat. No. 4,666,824 “Photopolymer process and composition employing a photooxidizable component capable of forming endoperoxides”, U.S. Pat. No. 4,915,804 “Titanate bound photosensitizer for producing singlet oxygen”, U.S. Pat. No. 4,921,589 “Polysiloxane bound photosensitizer for producing singlet oxygen”, U.S. Pat. No. 5,246,673 “Delta singlet oxygen continuous reactor”. Each of these discusses a reaction without discussing the reactor necessary for high volume or higher speed reactions.

In the prior art of reactors Burleson discloses in U.S. Pat. No. 4,640,782 a reactor that excites oxygen to various components using magnetic and electrical discharge that are known to produce ozone. His claim to producing singlet oxygen by combined exposure is not substantiated in the literature. In addition, Burleson is a tubular reactor without recirculation or irradiation.

Substantial prior art exists on SOG. Research to find an improved chemical mechanism of SOG has been exploratory. This exploratory research has not addressed full-scale production equipment and methods for SOG. In particular the use of a SOG for the COIL on a vehicle presents the need to carry a rechargeable SOG media and equipment to recharge the media. In the prior art of the Airborne Laser, a sufficient charge of BHP was loaded for the needs of an entire flight. The total weight of this flight charge engenders a weight penalty on the airframe.

Although the preferred embodiment of this invention is as a reactor in a singlet oxygen generator the principle that this invention teaches applies to the modification of the orbits of other materials rather than the ones herein referenced.

Objects

The objects of this current invention are to provide:

A reactor that provides a circulating pattern within the reactor chamber so that every surface of every particulate of the charge is exposed equally to an irradiation source mounted within the reactor during a relatively short period of time. The object is circulation not just agitation.

A reactor that speeds the energy transfer of irradiation to atomic orbital energy over a fixed bed.

A means and method of adding orbital energy to an atom either alone or as part of a molecule.

A means and method of producing singlet oxygen by irradiation from a common feedstock such as oxygen.

A transfer media for use in the reversible naphthalene to endoperoxide singlet oxygen exchange.

An irradiation source for energy transfer that is compatible with the natural absorption characteristics of the dye being used for an energy transfer media.

An accelerated dye-oxygen energy transfer.

An all gas phase release of singlet delta oxygen since the gas phase of singlet delta oxygen gives it a hundred-fold increase in energetic life.

A dry process to eliminate the water quench of BHP increasing efficiency of singlet production.

An addition of carbon nanofibers to the polymer beads used for transfer media to provide accelerated microwave energy transfer for some SOG rechargeable processes.

### SUMMARY OF INVENTION

This application relates to chemical reactors using a fluid bed to energize the orbital energy of atoms and more particularly to singlet oxygen generation (SOG) due to energy absorbed by various molecular forms of oxygen upon exposure to various energy forms including microwave, light, and EMF.

### BRIEF DESCRIPTION OF DRAWINGS

FIG. 1 is a flow diagram of a reaction to add orbital energy to common molecular oxygen.

FIG. 2 is a flow diagram of two reactions used for SOG.

FIG. 3 is a schematic of a light irradiated fluid bed after the teaching of this invention.

FIG. 4 s a schematic of a microwave heated and irradiated fluid bed after the teaching of this invention.

### DETAILED DESCRIPTION

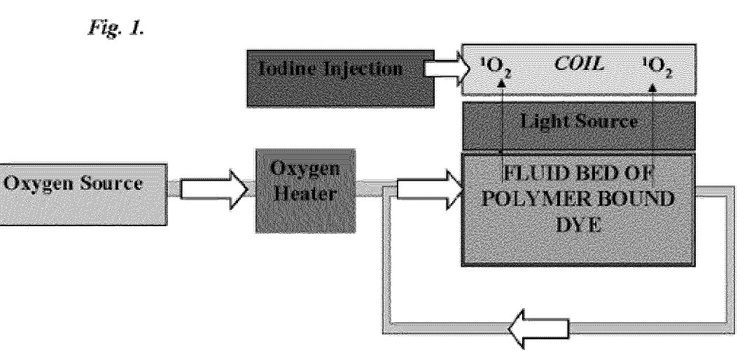

FIG. 1 shows a variation on a classic method of generation of singlet oxygen by dye-sensitized photolysis. Very briefly, a dye molecule absorbs a quantum of visible light, then transfers that energy to an oxygen molecule. The oxygen is thus promoted to its first excited state: singlet molecular oxygen.

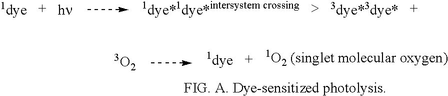

This reaction has not been done totally in the gas phase. Classically, the dye and the reaction substrate are dissolved in an appropriate solvent, oxygen is sparged through the solution, and the whole is irradiated with a strong visible light source. It is to be expected that only a small portion of the oxygen is available for reaction as singlet molecular oxygen. There are several reasons for the low yield. Since the singlet molecular oxygen is generated in the condensed phase, deactivation by solvent is an important process. Additionally, there is limited contact between the excited dye and the oxygen—only on the surface of the bubbles. Finally, it seems that the energy transfer process is not 100% efficient even if everything else goes well. But energy efficiency is not important if the yield is high! The presence of the dye is problematic from the viewpoint of a synthetic chemist. It must be purified away from the product which is frequently a highly sensitive molecule. To ease the purification process, attachment of the dye to an insoluble polymer bead has become a common and convenient way to introduce the dye to the system. It is less efficient for several reasons, but not so much so that it does not work.

The photolysys process is simple. Oxygen gas is flushed through a circulating bed of polymer bound dye while the dye is appropriately irradiated. The yield of singlet molecular oxygen is higher than in solution as its lifetime is substantially longer in the gas phase than in solution. Maximizing the yield rate only requires adjusting the gas pressure. The choice of some macroporous medium should allow substantial contact of oxygen with the excited dye and still allow for high throughput of oxygen.

Dye Sensitization: Many dyes can be used as sensitizers to transfer a quantum of energy to oxygen and promote it to the singlet state. One approach involves the immobilization of Rose Bengal on a polymer support. This dye is attractive in large part because the carboxylate group provided a useful handle for simple attachment to the polymer bead.

The primary consideration for choosing a dye involves matching the absorption maximum of the dye to the emission output of the lamp used. The Rose Bengal spectrum overlaps well with the output from a high-pressure sodium lamp such as used in streetlights. Methylene Blue can also be used with the sodium lamp. Tetraphenylporphyrin is more appropriate for use with a halogen lamp. The sodium lamp is preferred. It generates plenty of heat for the amount of light generated, but it is still a lot better than the high heat output of the halogen lamp.

The net reaction to generate singlet oxygen is as follows:
³O₂→¹O

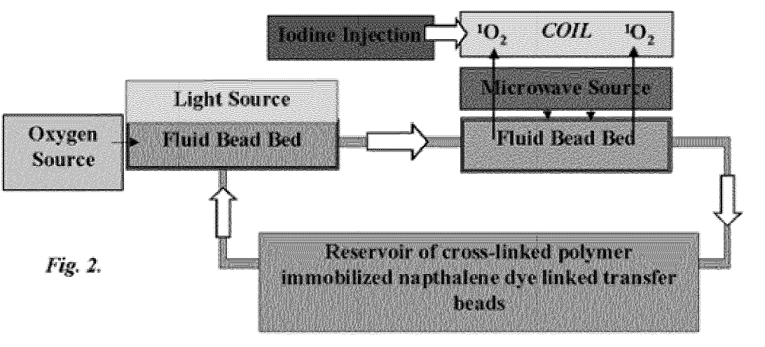

FIG. 2 shows the well-known Diels-Alder reaction of singlet molecular oxygen with a diene forming the six-membered ring product known as an endoperoxide.

Carefully chosen dienes allow the possibility of reversing the reaction. In the retro-Diels-Alder reaction, orbital conservation considerations result in the oxygen being liberated as singlet molecular oxygen. Aromatic molecules form ideal substrates for this approach. The restoration of aromaticity in the reverse reaction provides a driving force for the reaction. Far and away, the best aromatic for the job is naphthalene. It allows the singlet molecular oxygen to be generated at fairly low temperature and within time cycles.

The use of 1,4-dialkylsubstituted naphthalenes in this reaction is well known.

The polymer must have the dual ability to absorb microwaves effectively and also contain the substituted naphthalene with bound singlet molecular oxygen. The gas phase instead of solution, means that the free and active lifetime of the singlet molecular oxygen would be extended and, hence, its useful yield.

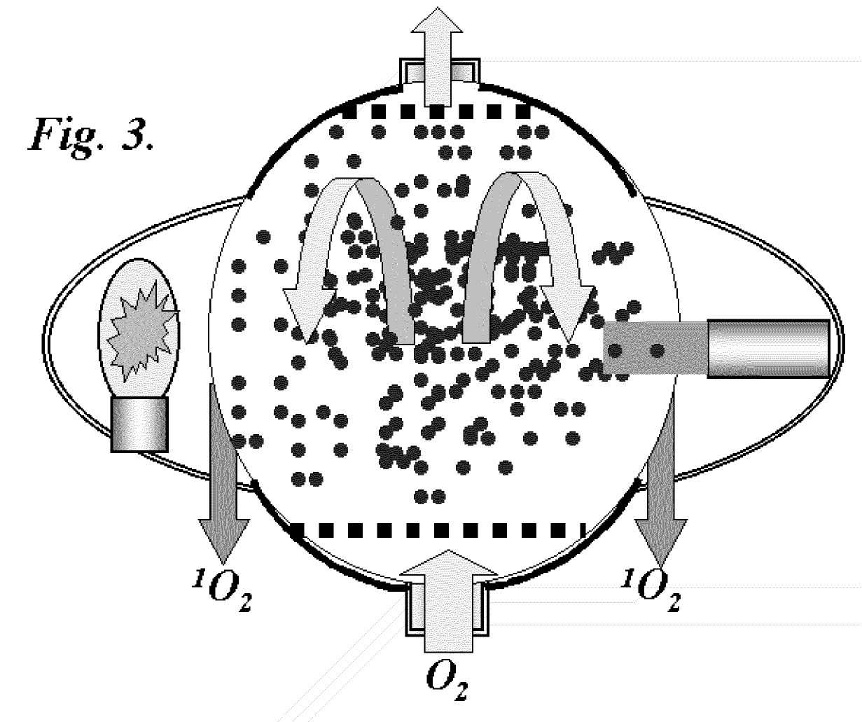

FIG. 3 shows a Light Irradiated Fluid Bed Reactor: The reactor is illuminated by intense multiple light sources. In the preferred embodiment the reactor can be used is to produce singlet oxygen by dye-sensitized photolysis. The spherical reactor is loaded with a charge of polymer beads that have been chemically bound to dye. When at rest the charge occupies between 30 and 60% of the reactor volume. Oxygen is introduced at pressure through the bottom of the reactor and a fountain-like circulation pattern begins to form as the polymer beds are agitated. Sodium vapor lights are positioned around the waist of the reactor and shine into the interior through windows in the sphere. As the beads become irradiated by the light, an energy transfer takes place from the energized dye to the oxygen surrounding the polymer bead. The excited singlet oxygen that is produced is then drawn off immediately from the downdraft at the perimeter of the reactor.

There are two ways this light irradiated reactor design can be used. As described above the reactor can be filled once with a single charge of polymer beads. The oxygen is the only added reactant. The beads would be rechanged when the bound dye on their surface was worn off from agitation. A single SOG reactor adjacent to the COIL could supply one and perhaps two trains of the COIL with singlet delta oxygen.

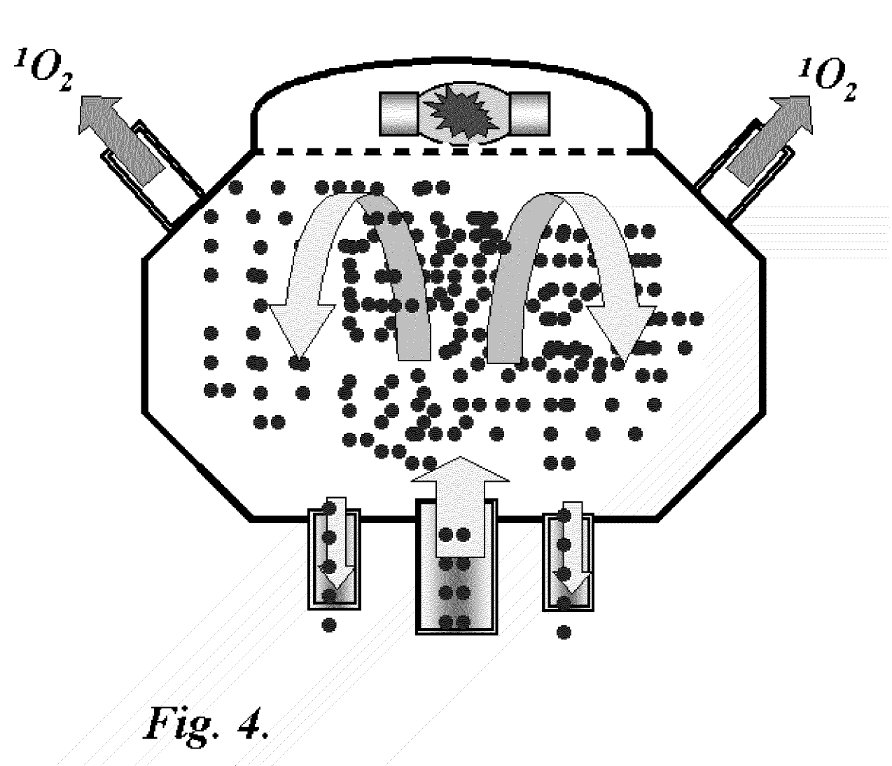

A second way this light irradiated reactor can be used is with the reversible Diels-Alder reaction. In this case, the reactor is used to recharge the media rather than the SOG (See FIG. 4, left). The reactor receives a continuiously flow of transfer media that has been depleted at the laser by a SOG reaction. The fluid bed is sized to provide a sufficient duration in the reactor for nearly complete recharging of the media. The recharged media then flows back to the SOG at the laser.

In FIG. 4 the components of a microwave reactor are shown heated by a microwave source or sources. The reactor is used to produce singlet oxygen by heated release from a polymer carrier The prismatic reactor receives a continuious flow of carrier media from the charger reactor. Oxygen is used in that reactor and is used to move the carrier media to the bottom of the reactor. The injected flow creates a fountain like circulation pattern as the polymer beds are agitated. Helium or another dilutant may also be injected with the oxygen to achieve high rates of agitation. Microwave emitters are at the crown of the reactor. As the carrier media becomes heated and excited by the microwave radiation, singlet delta oxygen is released. The excited singlet oxygen that is produced is then drawn off immediately from the downdraft at the perimeter of the reactor. The fluid bed is sized to provide a sufficient duration in the reactor for nearly complete discharge of the media. The exhaused media then flows back to a light power reactor to be recharged.

It will be understood by one skilled in the art that the surface of a purely spherical particulate may offer too small a surface area to meet the SOG release or capture requirements for either the light or microwave irradiated fluid beds. The polymers that will be selected are capable of being molded with a greater surface area by using a porous or dendritic pattern. This invention is an irradiating fluid bed reactor comprising a reactor chamber possessing means for energy irradiation. For the purposes of this invention energy irradiation encompasses any form or wavelength of light, heat, and/or microwave radiation either alone or in combination. For the purposes of this invention the inlet opening to admit gas under pressure can range from at least a first opening for introducing pressurized gas to a multitude of openings arranged in an array or bed. For the purposes of this invention the gas exhaust outlet may range from at least a second opening up to numerous exhaust openings. For the purposes of this invention the pressure of said gas selected to successively agitate by generally overcoming gravity, initiate flow, and circulate within said reactor a charge of particulate can range from one thousandth of a pound per square inch for a reactor operating in microgravity with light particulate, to pressure of two hundred pounds per square inch for a reactor operating at sea level with heavy particulate with a rapid circulation rate.

The particulate may have a chemically inactive component but it also possesses a chemical component that successively absorbs, emits, and transfers by contract said energy to at least one material selected to absorb said energy as atomic orbital energy for this atomic orbital absorptive. The chemical component or dye may be chosen from materials that are photo sensitive such as methylene blue or rose bengal or other photosensitive dye. The chemical component may also be chosen from various materials that are microwave sensitive such as carbon fibers. For the purposes of this invention by contact is defined to mean a conductive method of energy transfer whereby the energy laden material is in close proximity with the material targeted for absorbing the energy and achieving an increased orbital energy. It will be understood by one skilled in the art that this orbital energy may be captured by the targeted material for a short period of time before release to the surrounding ambient conditions.

For light irradiation processes the surface area of the particulate should be maximized. Thus the particulate should comprise particles that are smaller than twenty mesh openings to the square inch.

Few chemical reactions are pure in that they involve only one reactant. Thus this fluid bed reactor may have means provided for the introduction of a second reactant following the conclusion of said energy means absorption process. The size and configuration of said fluid bed reactor is selected to provide positive circulation in an environment of micro-gravity. The atoms that receive the additional orbital energy are combined within molecules. The particulate may comprise polymer beads made from PE, PP, HDPP, PU, Teflon, Lexan™, and other polymeric materials. In some cases the polymer beads are chemically attached to an energy sensitive dye such as Rose-Bengal, methylene blue, and other dyes. In other cases the polymer beads are attached to an organic material selected for its energy absorption and transfer capability, such as endoperoxide/napthalene. This organic material is chemically augmented and attached to a light and energy sensitive dye. The energy means may be a light source selected to be energy transfer compatible with said energy sensitive dye. The energy means may be a laser selected to be energy transfer compatible with said energy sensitive dye. The energy means may also be microwave radiation. The microwave energy capture capability of polymer beads is increased by the addition of carbon fibers and nanofibers to said polymer beads. The irradiation energy means may be EMF and magnetic.

For the generation of singlet oxygen, the gas provided for circulating flow is oxygen, selected of a pressure and temperature to generate singlet oxygen by energy transferred orbital excitement. Thus the gas for agitation of the fluid bed is also the targeted material. The fluid bed reactor may be provided by magnetic means of separation and removal of singlet oxygen for utility.

The gas provided for circulating flow may also be ozone, selected of a pressure and temperature to generate singlet oxygen by energy transferred orbital excitement.

The method of producing singlet oxygen within a reactor with a gas-agitated charge comprising the steps of introducing oxygen(O₂) in a container containing polymer beads attached to an appropriate dye, providing means for irradiation, and separating and withdrawing the singlet oxygen product by magnetic and egress means.

The method of producing singlet oxygen within two gas-agitated reactor chambers comprising the steps of providing a first process reactor chamber with a flowing particulate comprising a polymer bead, chemically attached to naphthalene, and in addition chemically attached to dye,providing within said first process reactor a irradiation source selected to convert in the presence of oxygen said naphthalene to endoperoxide,providing circulating means whereby said endoperoxide containing particulate, is transferred to a second reactor chamber, providing within said second reaction chamber means for microwave radiation heating whereby said endoperoxide is returned to its original naphthalene composition and singlet oxygen is released, and providing recirculating means whereby said particulate is returned to said first reactor chamber.

1. An irradiating fluid bed reactor comprising
a reactor chamber possessing means for energy irradiation,
with at least a first opening for introducing pressurized gas and at least a second opening for gas exhaust,
the pressure of said gas selected to agitate, initiate flow, and circulate generally within said reactor a charge of particulate,
said particulate possessing a chemical component that successively absorbs, emits, and transfers by contract said energy to at least one atomic orbital energy absorptive material.

2. The fluid bed reactor of claim 1 wherein said particulate comprises particles that are smaller than twenty mesh openings to the square inch.

3. The fluid bed reactor of claim 1 whereby mechanical and timing means is provided for the introduction of a second reactant following the conclusion of said energy means absorption process.

4. The fluid bed reactor of claim 1 whereby the size and configuration of said fluid bed reactor is selected to provide positive circulation in an environment of microgravity.

5. The fluid bed reactor of claim 1 whereby the atoms that receive the additional orbital energy are combined within molecules

6. The fluid bed reactor of claim 1 whereby said particulate comprises polymer beads.

7. The fluid bed reactor of claim 6 whereby said polymer beads are chemically attached to an energy sensitive dye.

8. The fluid bed reactor of claim 6 whereby said polymer beads are attached to an organic material selected for its energy absorption and transfer capability.

9. The fluid bed reactor of claim 8 whereby said organic material is chemically augmented and attached to said energy sensitive dye.

10. The fluid bed reactor of claim 1 whereby said energy means is a light source selected to be energy transfer compatible with said energy sensitive dye.

11. The fluid bed reactor of claim 1 whereby said energy means is a laser selected to be energy transfer compatible with said energy sensitive dye.

12. The fluid bed reactor of claim 1 whereby said energy means is microwave radiation.

13. The fluid bed reactor of claim 12 whereby the microwave energy capture capability of said polymer beads is increased by the addition of carbon nanofibers to said polymer beads.

14. The fluid bed reactor of claim 1 whereby said energy means is EMF and magnetic.

15. The fluid bed reactor of claim 1 whereby said gas provided for circulating flow is oxygen, selected of a pressure and temperature to generate singlet oxygen by energy transferred orbital excitement.

16. The fluid bed reactor of claim 15 whereby said fluid bed reactor is provided by magnetic means of separation and removal of singlet oxygen for utility.

17. The fluid bed reactor of claim 1 whereby said gas provided for circulating flow is ozone, selected of a pressure and temperature to generates singlet oxygen by energy transferred orbital excitement.

18. A method of producing singlet oxygen within a reactor with a gas-agitated charge comprising the steps of
introducing oxygen(O₂) in a container containing polymer beads attached to an appropriate dye,
providing means for irradiation, and
separating and withdrawing the singlet oxygen product by magnetic and egress means.

19. A method of producing singlet oxygen within two gas-agitated reactor chambers comprising the steps of
providing a first process reactor chamber with a flowing particulate comprising a polymer bead, chemically attached to naphthalene, and in addition chemically attached to dye,
providing within said first process reactor a irradiation source selected to convert in the presence of oxygen said naphthalene to endoperoxide,
providing circulating means whereby said endoperoxide containing particulate, is transferred to a second reactor chamber,
providing within said second reaction chamber means for microwave radiation heating whereby said endoperoxide is returned to its original naphthalene composition and singlet oxygen is released, and
providing recirculating means whereby said particulate is returned to said first reactor chamber.
